(19) United States
(12) Patent Application Publication
(10) Pub. No.: US 2010/0283631 A1
(43) Pub. Date: Nov. 11, 2010

(54) Smart Stop Sign System

(76) Inventor: ALTON M. BRYANT, South Riding, VA (US)

Correspondence Address: ALTON BRYANT, 26127 NIMBELTON SQUARE, SOUTH RIDING, VA, 20152, US

(21) Appl. No.: 12/352,459

(22) Filed: May 8, 2009

(51) Int. Cl. G08G 1/07

(52) U.S. Cl. 340/916

(57) ABSTRACT

A stop sign system that promotes safer, more orderly and more efficient vehicular and pedestrian traffic at intersections, which are barely or not eligible for traffic signal lights, by integrating a simple and easy-to-understand new lighting system into the familiar stop sign with automatic and manual controls. This system also promotes safer school crossings, as well as intersections with emergency situations and construction activity.

### BACKGROUND OF INVENTION

Every driver has approached a stop sign and could clearly see that there was no other vehicle at the intersection or any other reason whatsoever to stop, but we all take the extra time to obey the current traffic law of coming to a complete stop at all stop signs. We take the extra time to waste precious time for the completely pointless full stop only to avoid a traffic citation. We take the extra time to overuse and unnecessarily wear down our braking systems and components. We take the extra time to unnecessarily damage our environment by spending the extra time running our vehicles those few seconds longer than need be, and when one considers the number of vehicles on the road in this country per day, those few seconds can add up to years of extra carbons per day. We take the extra time to further harm the environment by using the excessive fuel needed to restart the motion of our vehicles from a dead stop. The Smart Stop Sign System completely eliminates all unnecessary full stops at intersections. Yet all vehicles would still be slowed down to a safe intersection speed, while ensuring that vehicles do come to a complete stop when it is necessary. The Smart Stop Sign System even employs solar energy to further improve our environment's health.

Every driver has approached a stop sign at what appears to be the same time as another driver to the human eye, then the drivers look at one another, hesitate, lunge forward in sync, brake in sync, and this can end a few different ways, some of which are not desirable. Every driver has sat in a queue at an intersection for an extended period of time, and when it is his/her turn to go through the intersection, another driver lunges forward at the same time, and the two drivers are stopped in the intersection happy they've avoided collision but (at the least) glaring at one another insinuating the other driver is to blame. The Smart Stop Sign System eliminates these traffic incidents altogether, by sensing the sequence of arrival down to the hundredth of a second and green-lighting the first driver, who never has to come to complete stop at all. Then, completely running the flow of traffic henceforth until all cars have cleared the intersection.

Every driver has spent too much time stopped at a traffic light intersection for what feels like an eternity when there have been no other vehicles at or near the intersection since your arrival. But still we wait and wait for the signals to finally come around to letting us get on our way. These systems are great when they are necessary, but so many traffic light intersections would be much better served using the Smart Stop Sign System in lieu of traffic lights. There would be no unnecessary waiting

### SUMMARY OF INVENTION

The Smart Stop Sign System will be used to promote safety and efficiency at traffic intersections where a standard All-Way Stop arrangement is not sufficient enough to ensure traffic safety and a standard Traffic Light system is overkill. The Smart Stop Sign System will improve safety and control at school crossing intersections and ease the burden on and reduce safety risks of school crossing guards. This system will also improve safety and enhance control for local authorities at intersections with emergency situations. Under certain circumstances, this system can ensure better control at these intersections where construction crews need traffic control. Under routine traffic situations this system will improve safety and efficiency for vehicle and pedestrian traffic; ensure full stops when stopping is necessary; save motorists time and unnecessary wear and tear on their vehicles; reduce frustration and road rage; reduce waste and vehicle emissions; and promote environmental welfare.

There are many environmental benefits to the Smart Stop Sign System. The material used to make the Smart Stop Sign shall primarily be recycled steel or aluminum whichever is most plentiful. In fact, many of the facades for the new Smart Stop Signs can be produced by retrofitting currently employed stop signs. The Smart Stop Sign System's primary power supply will be solar powered batteries, and only employ utility power when rechargeable battery levels are depleted below 15% until battery levels are fully charged again. The Smart Stop Sign System allows more vehicles to only slow down then continue moving through intersections without stopping when traffics deems it is not necessary to come to a complete stop. This will save fuel, engine wear and tear, and improve brake system longevity, which reduces our use of these materials. This also reduces carbon emissions and brake dust into the atmosphere.

### DESCRIPTION OF COMPONENTS

The Smart Stop Sign System will be comprised of the following devices: A Smart Stop Sign at each corner of a selected intersection as Stop Signs are currently positioned. Each Smart Stop Sign's facade is the same size, shape, color, font and reflectivity as the current models of standard Stop Signs. The major difference between the standard stop sign and the Smart Stop Sign is the lighting system. The sign's façade will feature sunken shafts for Light Emitting Diodes (LEDs) to shine direct lighting forward to traffic and prevent omni directional radiating light from disturbing residents in close proximity to intersections employing the Smart Stop Sign System. The lighting system on the Smart Stop Sign will consist of three horizontal fields of colored LEDs as shown in FIG. 1. The top field, which covers the top pentagon section above the word “STOP”, and the bottom field, which covers the lower pentagon section below the word “STOP”, will consist of light shafts through which red LEDs will shine. The center rectangle containing the word “STOP” will consist of a field of light shafts through which green LEDs may shine. The width of the Smart Stop Sign will be just deep enough to house the circuit board containing the rechargeable batteries and LED circuitry. The rear steel panel of the Smart Stop Sign (FIG. 2) will contain the LED circuitry feeding the necessary cables down through the post upon which the Smart Stop Sign is set and up to the solar panel seated atop the Smart Stop Sign. The LEDs' position in the circuitry will align with the corresponding light shafts provided by the façade panel. The LEDs are to remain one-quarter (¼) inch below the surface of the façade panel. During the initial employment of the Smart Stop Sign System there will be retroreflective signs affixed to the Smart Stop Sign post which will read “WAIT FOR SOLID GREEN SIGNAL.” Affixed to the posts of Smart Stop Signs at appointed intersections will be an optional LED indicator reading “MANUAL CONTROL” which is to be illuminated during periods when the Manual Intersection Control Override is employed at the appointed intersections.

The Vehicle Weight Detector System will be buried beneath the asphalt as at intersections using traffic lights. They will be strategically placed at locally determined positions according to size and speed limit of intersection. This placement will be such that vehicles will be able to approach the intersection, reduce to a locally determined safe speed, then (when applicable) proceed through the intersection without coming to a complete stop. The smallest vehicle to trigger the Smart Stop Sign System (whether 400-pound motorcycle on the road or 150-pound bicycle in a bicycle lane) will be determined by the local legislation.

The Pedestrian Crossing Signal will be affixed to each Smart Stop Sign post as in FIG. 3 and FIG. 4. These optional crossing signals will work similarly to those employed at traffic light intersections using the “WALK” and “Do Not Walk” indicators. At rest each Pedestrian Crossing Signal will give a solid “Do Not Walk” indication. Each Smart Stop Sign post will house a Pedestrian Crossing Button (FIG. 3, FIG. 4), which when depressed will cause all Smart Stop Signs at that intersection to light Fields 1 and 3 solid red and change from a “Do Not Walk” indication on the Pedestrian Crossing Signal to a “WALK” indication for a locally determined period of time. After this time expires, the “Do Not Walk” indication will flash for a locally determined period of time after which the Pedestrian Crossing Signal will illuminate a solid “Do Not Walk” indication. One second later the Smart Stop Sign will then resume proper timing for the vehicles at the intersection.

The Central Timing Control System is the computer system which will be housed in a locked steel utility box at or near the intersection employing the Smart Stop Sign System. The Central Timing Control System will be very similar to those positioned near traffic light intersections. This system is the brain of the entire intersection. All Smart Stop Signs, Pedestrian Crossing Signals, Pedestrian Crossing Buttons, energy systems, Manual Intersection Control Override (MICO) and Vehicle Weight Detectors will be connected to, controlled by and timed through this system. The Central Timing Control System will also save all traffic data and manual input history for up to 48 hours. This option is for those instances when this traffic data will be useful for any type of necessary investigation.

The Manual Intersection Control Override will be a handheld manual override control system locked inside the utility box housing the Central Timing Control System, which is to be used exclusively by local authorities with access keys (such as crossing guards, police officers, fire and rescue personnel, utility personnel and construction crews (access rights to be determined and granted by local officials). This handheld controller's design can be shall be similar to that of the illustration in FIG. 5. The design shall include a “Resume” button, which releases all activated buttons and ends manual control—this button will be shaped as an arrow pointing toward the center of the intersection to help orient the user; a “Walk” button, which illuminates all Walk indicators on the Pedestrian Crossing Signals and illuminates solid red LEDs in fields 1 and 3 on all Smart Stop Signs until button is released; a “Do Not Walk” button, which allows user to disable all Pedestrian Crossing Buttons and allows vehicular traffic to resume without interruption until user determines it is appropriate to allow pedestrians to cross, at which point the user would select the “Walk” button; an “All Stop” button, which begins manual control and illuminates solid red LEDs in fields 1 and 3 on all Smart Stop Signs and illuminates “Do Not Walk” on all Pedestrian Crossing Signals; and single buttons to control each Smart Stop Sign individually—the button controlling the Smart Stop Sign at the corner where this Manual Intersection Control Override is located will be indicated by different shape than the other buttons to help orient the user. This eliminates the dangerous deed of personnel standing in the middle of the intersection to control traffic.

### DESCRIPTION OF THE DRAWINGS

FIG. 1: Illustration shows the façade of a Smart Stop Sign. The tiny circles throughout the plane of the sign represent light shafts into which the colored LEDs seat and through which the colored LEDs will shine. The drawing also designates the three separate fields of the Smart Stop Sign and the colors of the LEDs to be assigned to those fields.

FIG. 2: Illustration shows the Smart Stop Sign with the façade removed. The inside of the sign contains solar rechargeable batteries, the colored LEDs, which stand into their respective shafts, in their proper fields, and the circuitry. There are openings at the top and bottom of the Smart Stop Sign for wires and cables to route to and from the solar panel (top) and the Central Timing Control System (bottom).

FIG. 3: Illustration shows a Smart Stop Sign assembly from a pedestrian's point of view as he/she approaches the intersection. The Smart Stop Sign is affixed to the post with attached solar panel atop sign post and Pedestrian Crossing Signals affixed to sign post below Smart Stop Sign with the indicators facing the directions indicated in the drawing. This illustration also shows Pedestrian Crossing Buttons affixed to the sign post below the Smart Stop Sign. The Swivel Ball illustrated in the drawing is used to position solar panel to maximize benefit of the sun's power to the system.

FIG. 4: Illustration shows the top view of the fitment of the Pedestrian Crossing Signals and the Pedestrian Crossing Buttons as affixed to the sign post with the indicators facing the directions of the arrows.

FIG. 5: Illustration shows an example of the Manual Intersection Control Override Handheld Control Panel. The label along the bottom states “RED BUTTONS TURN GREEN WHEN ACTIVATED.” This lets the user know that the button that is green is the active button on the panel. Illustrated buttons included on this panel are: “Do Not Walk”, “Walk,” “Resume,” “All Stop,” and individual Smart Stop Sign control buttons for the intersection.

FIG. 6: Illustration shows a Smart Stop Sign assembly from the same perspective as FIG. 3, but the optional “MANUAL CONTROL” indicator is affixed to the post below the Pedestrian Crossing Button. This alerts all pedestrian and vehicular traffic that the intersection is being manually controlled by an approved official using the Manual Intersection Control Override

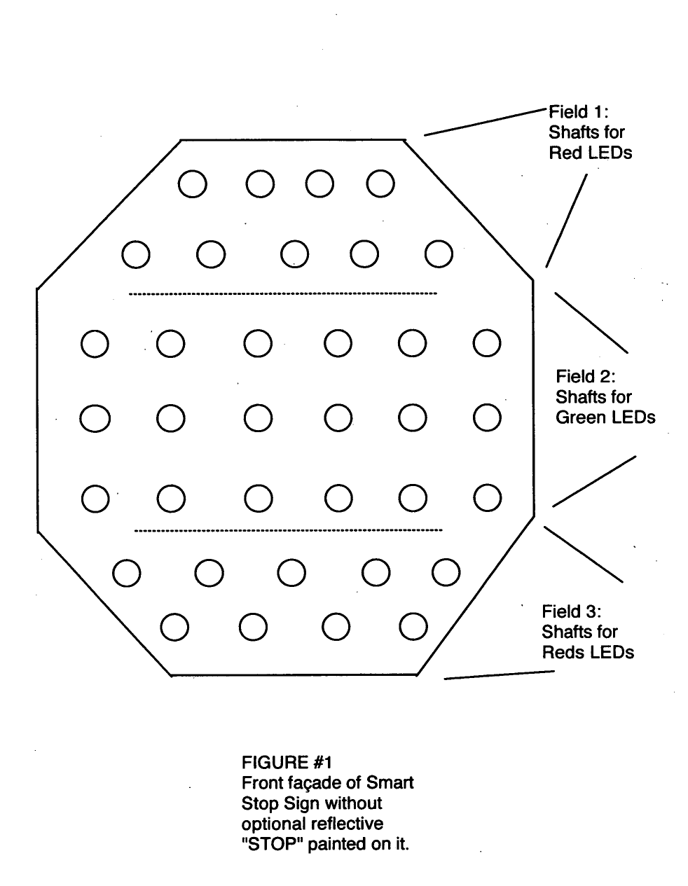

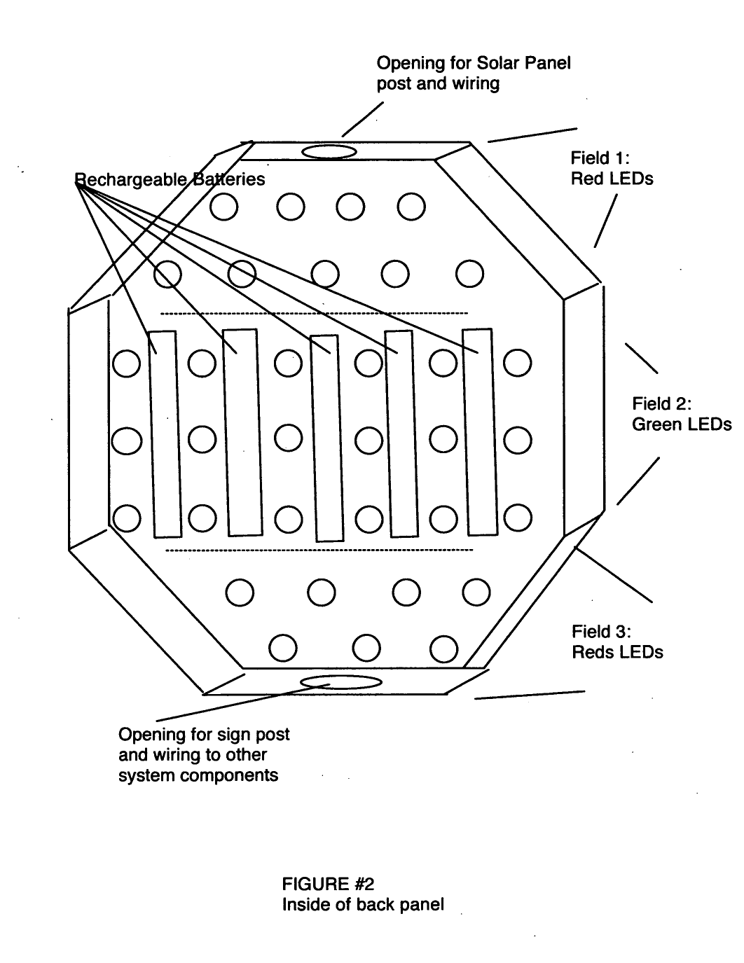

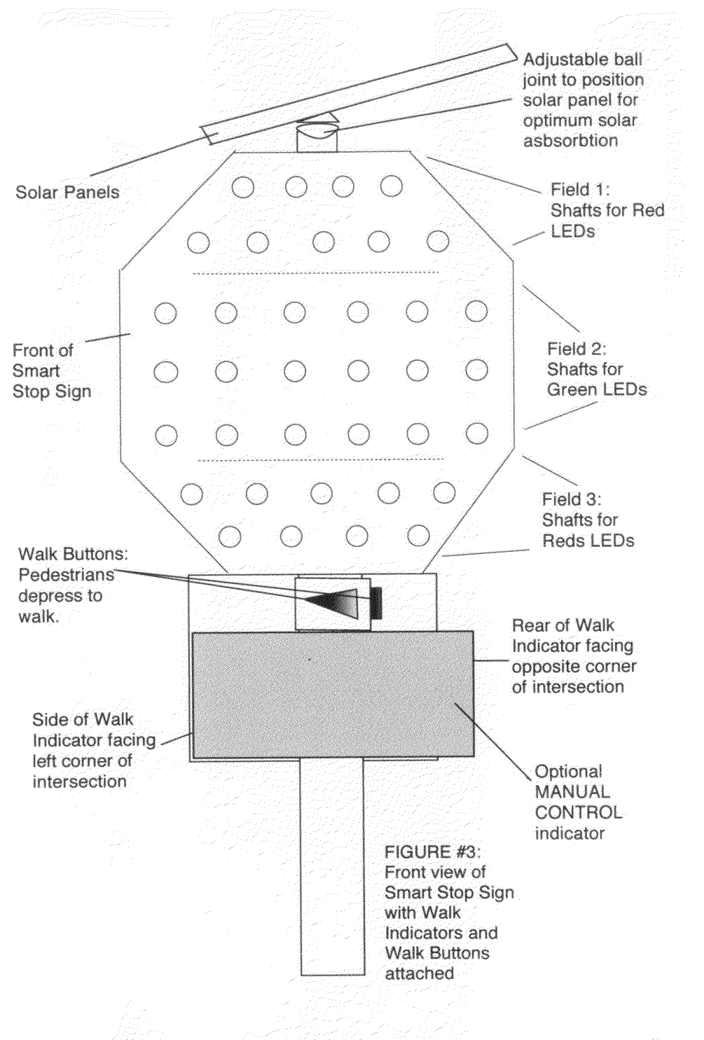

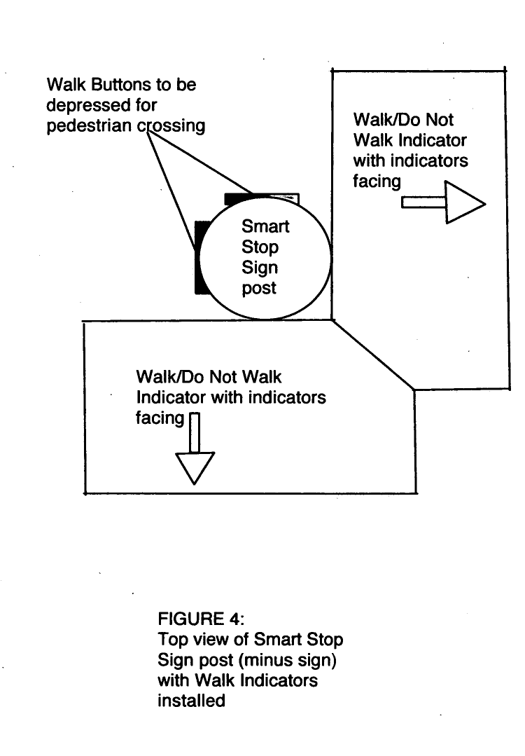

### DETAILED DESCRIPTION OF SMART STOP SIGN SYSTEM

These will be used at intersections where all-way stop signs are not safe enough and traffic lights are overkill. There will be a Smart Stop Sign posted on each corner as stop signs are today. When no vehicles are detected at the intersection, all Smart Stop Signs at the intersection will illuminate alternating red between fields 1 and 3. The LEDs will be sunken below the surface of the Smart Stop Sign to limit neighborhood disturbance to nearby residents. When a single vehicle approaches the intersection, the driver will see the alternating red until the vehicle's weight is detected by the Vehicle Weight Detector, then that driver's Smart Stop Sign will illuminate solid green LEDs in field 2, and simultaneously all other Smart Stop Signs at the intersection will illuminate solid red in both fields 1 and 3, and the driver may proceed through the intersection. After the locally determined period of time (probably about 2 seconds) the green Smart Stop Sign will change from solid green to flashing green in field 2 for the locally determined period of time (probably about 2 seconds). If there are no other cars at the intersection after that locally determined period of time, all Smart Stop Signs at the intersection will return to rest (illuminating alternating red between fields 1 and 3).

When two vehicles approach the intersection in succession from the same direction and no other vehicles are present at the intersection, the two approaching drivers will see alternating red signal until the first vehicle is detected, then the Smart Stop Sign will signal solid green then flashing green for the locally determined periods of time, then will return to solid green and flashing green for the second vehicle's locally determined period of time. If there are still no other cars at the intersection after that locally determined period of time, all Smart Stop Signs at the intersection will return to rest (illuminating alternating red between fields 1 and 3).

When two vehicles approach from different directions at about the same time, the Vehicle Weight Detector System will determine which vehicle arrived first down to the 0.01 second. As the vehicles approach both drivers will see an alternating red signal until the first vehicle is detected, the corresponding first Smart Stop Sign will display the solid green and flashing green signals for the locally determined periods of time. While the first Smart Stop Sign is displaying its “GO” signals all other Smart Stop Signs will each display a solid red signal. After the first Smart Stop Sign has gone through the “GO” cycle it will display the solid red “STOP” signal at which time the second Smart Stop Sign will display the solid green and flashing green “GO” signals for the locally determined periods of time. Meanwhile all of the other Smart Stop Signs will display the solid red “STOP” signal. The after the second Smart Stop Sign has gone through the “GO” signals, if no other vehicles are present at the intersection, all Smart Stop Signs will return to rest (alternating red signal).

When the intersection has a queue of vehicles at each Smart Stop Sign, the Smart Stop Sign System will run the sequence of the intersection according to vehicle arrival sequence at the intersection. Each Smart Stop Sign will display “GO” signals in the proper sequence and timing.

When a pedestrian depresses any Pedestrian Crossing Button at any corner at an intersection employing the Smart Stop Sign system, if there is an actively crossing vehicle, after that Smart Stop Sign completes its “GO” cycle, all Smart Stop Signs will illuminate solid red LEDs in fields 1 and 3 and all Pedestrian Crossing Signals will display a solid “WALK” signal for the locally determined period of time and then the Pedestrian Crossing Signals will display a flashing “Do Not Walk” signal for the locally determined period of time before returning to a solid “Do Not Walk” indication. The Pedestrian Crossing Button can be manually disabled by authorized personnel using the Manual Intersection Control Override.

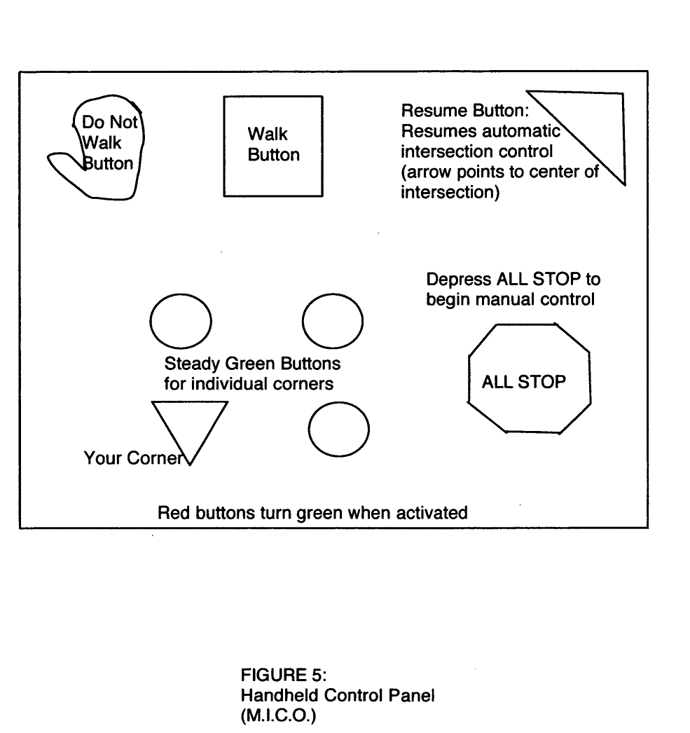

When the handheld Manual Intersection Control Override is removed from the utility box to be used by authorized personnel, it works as follows: 1) the user orients the controller with the “RESUME” arrow pointing toward the center of the intersection and the star-shaped button in FIG. 5 positioned closest to the user; 2) after the Manual Intersection Control Override is properly positioned, the user should see the “RESUME” button is illuminated green and all other buttons will be illuminated red; 3) when the user wants to wants to begin manual control or stop all vehicular and pedestrian traffic in manual mode, he/she will depress the “ALL STOP” button, which will change from red to green, all other buttons will illuminate red, and the “MANUAL CONTROL” indicators on each Smart Stop Sign post will illuminate until the user depresses the “RESUME” button; when the user wishes to hold all vehicular traffic and allow pedestrian traffic to cross, he/she will select the “WALK” button, which will then change from red to green, and all other buttons will illuminate red; when the user wishes to hold all pedestrian traffic but not interfere with vehicular traffic the user will select the “DO NOT WALK” button, which will then change from red to green, and all other buttons will illuminate red; when the user desires to allow traffic from one particular direction to proceed through the intersection without waiting for other traffic the user would select the “Continuous Green” button for that particular Smart Stop Sign, this will cause the selected Smart Stop Sign to display a continuous solid green signal while all other Smart Stop Signs will display solid red in fields 1 and 3, and all Pedestrian Crossing Signals will display “Do Not Walk” signals until user chooses another selection, and as with all selected buttons, the chosen button will illuminate green while selected, and all others will illuminate red; finally, when the user wishes to discontinue manual control of the system, he/she will depress the “RESUME” button, which will then illuminate green and relinquish all control back to the automated system. At this point the user may restore the Manual Intersection Control Override to its storage place inside the utility box.

1. An system which controls vehicular and pedestrian traffic at slightly busy intersections comprising: a solar-powered Smart Stop Signs; Vehicle Weight Detectors; Pedestrian Crossing Signals; Central Timing Control System; and a Manual Intersection Control Override at each intersection.

2. The system as set forth in claim 1, when active, will make intersections utilizing the system will have a safer and more organized flow of traffic, alleviating confusion of the sequence, than current stop sign intersections.

3. The method of sequencing in claim 2 is detection of vehicular presence using Vehicle Weight Detectors and sequencing multiple vehicles using the Central Timing Control System by tracking their arrival at the detection point down to 0.01 second and releasing (or giving a green light to) each vehicle using Smart Stop Signs (as mentioned in claim 1) in the sequence of its arrival to the detection point.

4. The method of safety of claim 2 is placing Pedestrian Crossing Buttons at each corner of an intersection whereby pedestrians may press button during heavy traffic periods. When the Pedestrian Crossing Button is depressed all vehicular traffic will be held via Smart Stop Signs, all Pedestrian Crossing Signals will signal for pedestrians to cross for a locally determined period of time. At the end of this locally determined period of time, the Pedestrian Crossing Signals will signal for pedestrians to stop crossing, and the Central Timing Control System will resume the sequence of vehicular traffic via the Smart Stop Signs.

5. The method of safety in claim 2 employing Manual Intersection Control Override would involve pre-approved official personnel, such as crossing guards, police, firefighters, construction workers, etc., turning off the automatic Central Timing Control System with the handheld device (Manual Intersection Control Override) and controlling the vehicular and pedestrian traffic signals manually from the safety of the sidewalk or their own vehicle, as opposed to standing in the middle of the intersection. Each Smart Stop Sign will have a “MANUAL CONTROL” indicator illuminated during periods of manual control.
